(19) United States
(12) Patent Application Publication
(10) Pub. No.: US 2003/0233413 A1
(43) Pub. Date: Dec. 18, 2003

(54) Method and apparatus for scheduling delivery of electronic mail messages

(75) Inventor: Craig Henry Becker, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/171,946

(22) Filed: Jun. 13, 2002

(51) Int. Cl. G06F 15/16

(52) U.S. Cl. 709/206

(57) ABSTRACT

A method, apparatus, and computer instructions for scheduling suspension of email delivery to users on an email list. A graphical user interface is sent to a client in which the graphical user interface is used to facilitate user input setting a period of time during which a user is suspended from the email list. This graphical user interface may be, for example, a Web page or an applet embedded in a Web page. The user input setting the period of time is received. Email sent to subscribers of the email list is suspended for the user during the period of time. Emails sent to the subscribers of the email list during the period of time remain unsent to the user after the period of time ends.

### BACKGROUND OF THE INVENTION

1. Technical Field

The present invention relates generally to an improved data processing system, and in particular, to a method and apparatus for processing electronic mail messages. Still more particularly, the present invention provides a method and apparatus for scheduling suspension of delivery of electronic mail messages for a set of subscribers.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to send electronic mail messages, which are also referred to as email. Email is frequently used as a means of communication between users on a one-to-one basis. Further, email lists have become a popular tool for many users. An email list is a tool that allows multiple email addresses to be reached by sending an email to a single email address. This single email address contains the email addresses of all the people the user may want to communicate with on a specific mailing list. When any member of the list sends a message to the address of the mailing list, everyone on the list automatically receives the email message. Email listservers, also referred to as “listservs” are quite common on the Internet for this reason. Many times, these listservs are organized around a specific subject or area. These lists may be used for mundane purposes such as scheduling meetings and providing simple notifications or may be used for other purposes like carrying on on-line conversations. With a listserv, no need is present for each person who is a member or subscriber to the list to maintain their own address book of the other members of subscribers.

With listservs, users may receive many email messages, especially if the particular list contains many members who are active in sending messages. Many users also belong to multiple email lists and often times have to review many messages in a single day. If a user is away or unable to check email for a period of time, the amount of messages often times become too numerous for the user to review when the user returns. The user may belong to different lists, which mainly serve as informational or do not provide critical information. As a result, the user often times has to delete all of the messages received while the user was away. Currently, the only way a user can avoid having all of these messages sent to the user is to cancel the subscription before the user leaves and resubscribe to the list when the user returns. Otherwise, the user is inundated with messages from the email list. Alternatively, the user may email the listserv owner/moderator to ask them to manually turn off or suspend their subscription. Currently, the owner or moderator of the listserv must manually remove the user from the email list or turn off email for the user and place the user back on the list or turn the email back on for the user at the appropriate times. Such a task becomes tedious, especially if the owner or moderator handles a number of listservs in which such requests are made.

Therefore, it would be advantageous to have an improved method, apparatus, and computer instructions for handling scheduling of email from listservs or email listservers.

### SUMMARY OF THE INVENTION

The present invention provides a method, apparatus, and computer instructions for scheduling suspension of email delivery to users on an email list. A graphical user interface is sent to a client in which the graphical user interface is used to facilitate user input setting a period of time during which a user is suspended from the email list. This graphical user interface may be, for example, a Web page or an applet embedded in a Web page. The user input setting the period of time is received. Email sent to subscribers of the email list is suspended for the user during the period of time. Emails sent to the subscribers of the email list during the period of time remain unsent to the user after the period of time ends.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in scheduling email delivery for email listservers in accordance with a preferred embodiment of the present invention;

FIG. 5 is a diagram illustrating a table for scheduling delivery of email in accordance with a preferred embodiment of the present invention;

FIG. 6 is a diagram illustrating a graphical user interface for scheduling delivery of email for an email list in accordance with a preferred embodiment of the present invention;

FIG. 7 is a flowchart of a process used for scheduling delivery of email for email lists in accordance with a preferred embodiment of the present invention; and

FIG. 8 is a flowchart of a process used for sending email to users subscribing to an email list in accordance with a preferred embodiment of the present invention.

### DETAILED DESCRIPTION OF THE PREFERRED EMBODIMENT

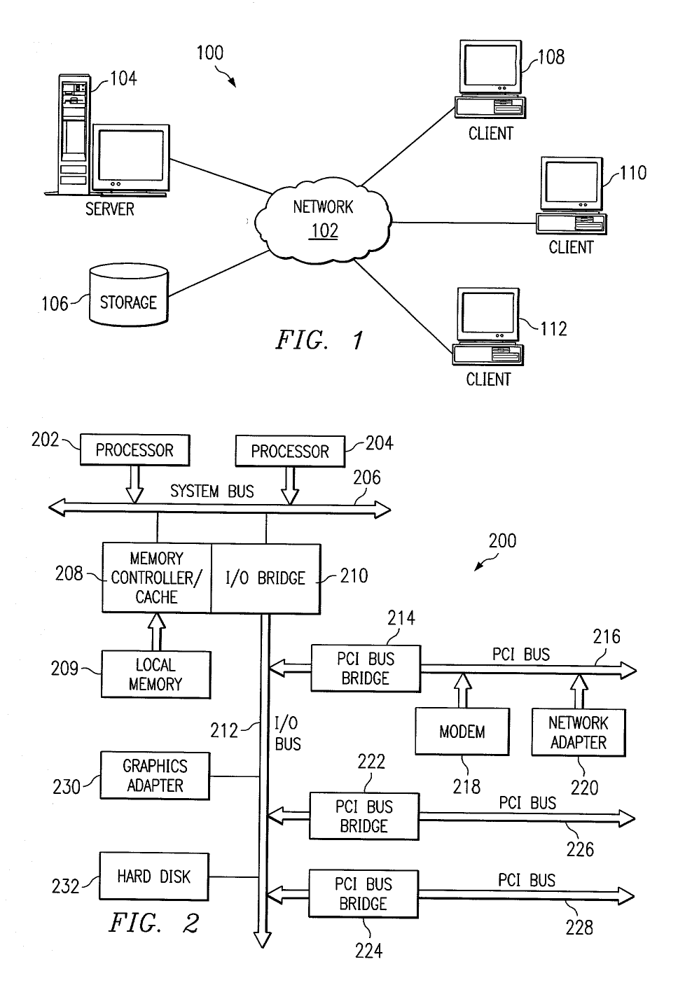

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

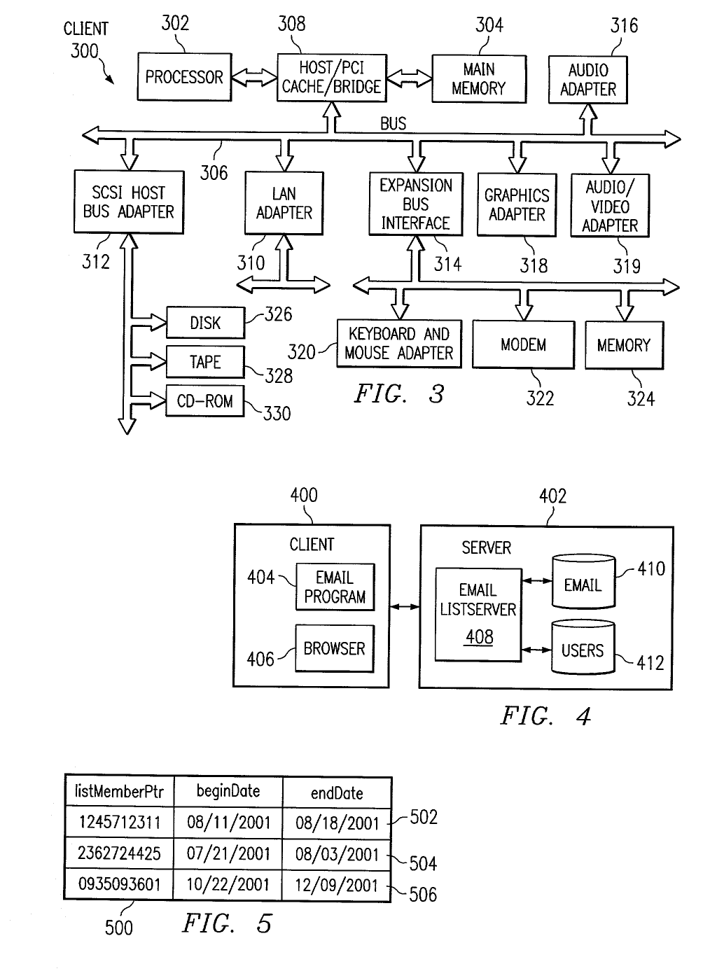

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference now to FIG. 4, a diagram illustrating components used in scheduling email delivery for email listservers is depicted in accordance with a preferred embodiment of the present invention. In this example, client 400 may receive email from an email list hosted at server 402. Client 400 may be implemented using data processing system 300 in FIG. 3, while server 402 may be implemented using data processing system 200 in FIG. 2. The user may view email through email program 404 or through browser 406. In particular, email is delivered through email listserver 408, which delivers email 410 to users subscribing to the email list. The list of users and their addresses is stored in users database 412.

The present invention provides a mechanism, which allows a user or moderator to schedule suspension of a user's email from an email list in advance without requiring the user to cancel the subscription when the user desires to cease receiving the email and resubscribe on the date the user desires to again receive email from the email list. In other words, the user does not have to cancel the subscription at the moment they want to cease receiving email from the listserv and resubscribe to the listserv at the moment they want to begin receiving email from the listserv. The mechanism of the present invention avoids having a moderator in charge of a list being besieged by requests to take the user off the list and then have the user put back on the list. Instead, the mechanism of the present invention provides an interface, which allows a user to specify a beginning date to begin suspending the user's email and an end date to end suspension of the user's email. One advantage provided by the mechanism of the present invention is the ability for a subscriber to schedule suspension of email from a listserv in advance. Further, the user also may generate a request to immediately end the suspension if needed.

In these examples, the interface is a graphical user interface, which is Web based and may be displayed through browser 406. In fact, this mechanism allows for a user to “suspend” the user's subscription to the email list for a period of time. When the period begins, the user is “suspended” from the list and email sent to the email list is not sent to the user. When the suspension ends, the user will begin receiving email directed to the email list, but does not receive any of the email sent during the period of time the subscription was suspended. Additionally, this interface may also be used by a listserv owner/moderator to allow for advance scheduling of email suspension. By using such a feature, a listserv owner or moderator may schedule suspension of a subscription ahead of time. This avoids the owner or moderator having to cancel a user subscription for a user at the time the user desires to cease receiving email from the listserv and then having to resubscribe the user to the listserv at the time the user desires to again begin receiving email.

Turning now to FIG. 5, a diagram illustrating a table for scheduling delivery of email is depicted in accordance with a preferred embodiment of the present invention. In this example, suspension list 500 is a table, which may be stored in users database 412 in FIG. 4. Suspension list 500 is used by email listserver 408 in FIG. 4 to identify users, subscribing to the email list, who are not to receive email.

Suspension list 500 contains entries 502, 504, and 506. As illustrated, each entry includes a list member pointer or identifier, a beginning date, and an end date. This information is used to identify the user and the period of time in which email is not to be sent to the user. Email not sent to the user based on this list is never sent to the user in contrast to an unsuccessful attempt to send email to a user who has not suspended their subscription. In the latter case, the email listserver may try to resend the email at a later point in time. Email is never sent to suspended subscribers.

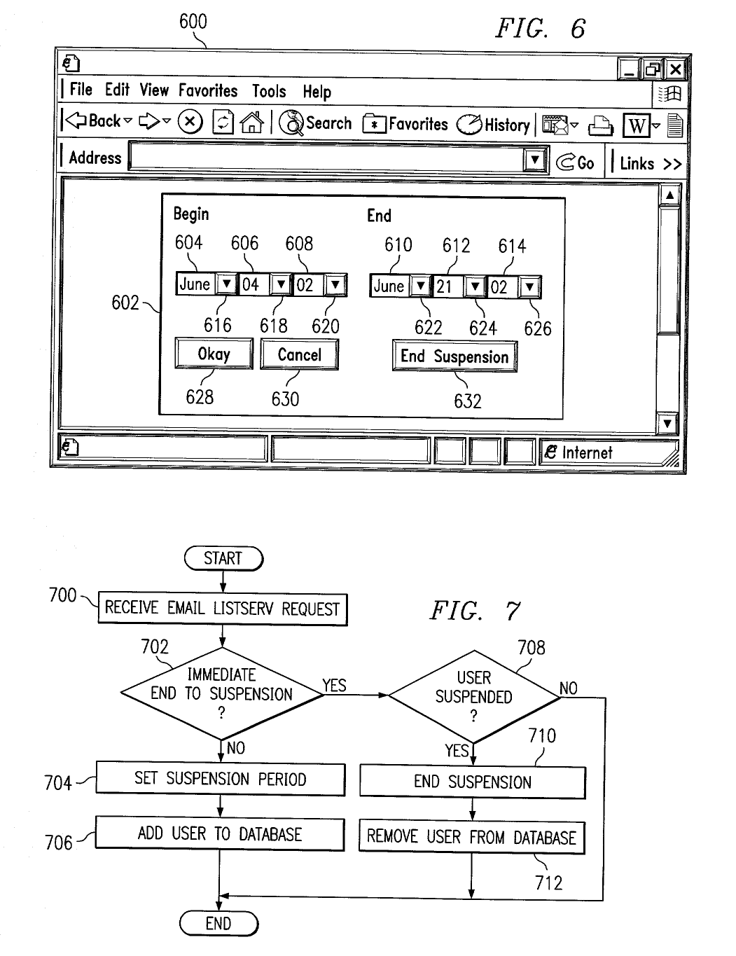

With reference now to FIG. 6, a diagram illustrating a graphical user interface for scheduling delivery of email for an email list is depicted in accordance with a preferred embodiment of the present invention. Browser 600 is an example of browser 406 in FIG. 4 in which graphical user interface 602 is presented to a user for scheduling delivery of email on an email list.

Graphical user interface 602 allows a user to set a beginning date in fields 604, 606, and 608, which are fields for month, day, and year respectively. Fields 610, 612, and 614 allow a user to select an ending date. Field 610 allows the selection of a month, field 612 allows the selection of a day, and field 614 allows the selection of a year. Depending on the implementation, the beginning and end dates may have additional granularity, such as allowing a user to set the particular hour and minutes for beginning and ending start dates.

The information may be entered by the user or drop-down menus may be presented for the different dates through the selection of controls 616, 618, 620, 622, 624, and 626. If the user is satisfied with the period of time set by the begin and end dates in graphical user interface 602, the user may select “okay” button 628 to send the request to the email listserver for processing. If the user does not wish to send the request, the request may be cancelled by selecting “cancel” button 630.

Additionally, graphical user interface 602 includes “end suspension” button 632, which is used to generate a request to immediately end suspension of a subscription to an email list. This request may be generated when the user's subscription to the list is currently suspended, but the user decides to end the suspension. Graphical user interface 602 may be presented as part of an HTML page displayed within browser 600 or presented through the use of an applet in conjunction with the HTML page depending on the particular implementation. The graphical user interface may be implemented in numerous ways. In addition to being sent as Web page or applet, the interface may be, for example, implemented as an extensible markup language (XML) based Web service. A Web based service is basically a Remote Procedure Call system performed over the Internet. Web Services use XML as the interchange medium. For example, a Java program might call a function that invokes a Web Service, such as a stock quote service. The parameters and other information needed to make the call are converted to XML, then these converted parameters are sent out over HTTP to the host machine that houses the specific stock quote Web service. The stock quote service reads and parses the XML, determines what function to apply (in this case, what stock quote to deliver), encodes the return information into XML, and then sends this XML package back, also via HTTP. When the XML is received, it is parsed and the stock quote data is turned into Java data, which is then passed back to the Java program, which sent the request.

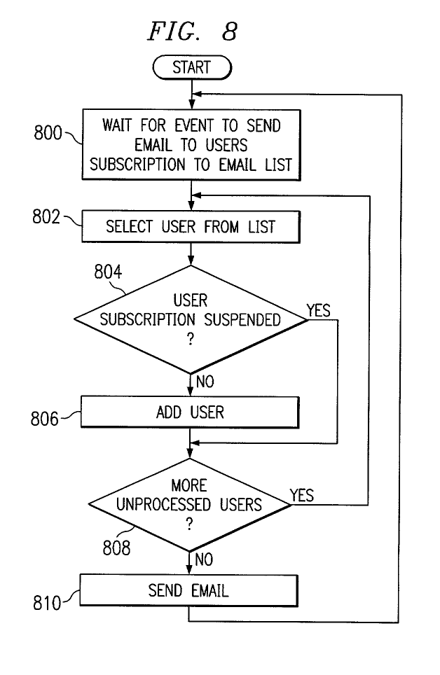

With reference now to FIG. 7, a flowchart of a process used for scheduling delivery of email for email lists is depicted in accordance with a preferred embodiment of the present invention. The process illustrated in FIG. 7 may be implemented in an email listserver, such as email listserver 408 in FIG. 4. The process begins by receiving an email listserv request (step 700). This request may be received from a client, such as client 400 in FIG. 4, using an interface, such as graphical user interface 602 in FIG. 6. A determination is made as to whether to immediately end suspension (step 702). If suspension is not to be immediately ended, the request is a request to set a suspension to the user subscription. A suspension period is set (step 704). Thereafter, the user and the suspension period are added to a suspension list in a database, such as users database 412 in FIG. 4 (step 706) with the process terminating thereafter. This entry is used to prevent email from being sent to the user during the suspension period.

Returning again to step 702, if suspension is to end immediately, a determination is made as to whether the user's subscription to the email list is currently suspended (step 708). If the user's subscription is currently suspended, suspension is ended (step 710). In ending the suspension, the user is removed from a suspension list in a users database, such as users database 412 in FIG. 4 (step 712) and the process terminates thereafter. With reference again to step 708, if the user's subscription is not suspended, the process terminates.

Turning now to FIG. 8, a flowchart of a process used for sending email to users subscribing to an email list is depicted in accordance with a preferred embodiment of the present invention. The process illustrated in FIG. 8 may be implemented in an email listserver such as email listserver 408 in FIG. 4.

The process begins by waiting for an event to send email to a user's subscription to email list (step 800). A user is selected from the list (step 802). In these examples, the event is a receipt of an email from one of the users or an email generated by the moderator for the email list. A determination is made as to whether the user subscription is suspended (step 804). If the user subscription is not suspended, the user is added (step 806).

Next, a determination is made as to whether more unprocessed users are present (step 808). If more unprocessed users are absent, an email is sent (step 810) and the process returns to step 800 as described above. Returning again to step 808, if more unprocessed users are present, the process returns to step 802 as described above. With reference again to step 804, if the user subscription is suspended, the process proceeds to step 808 as described above.

Thus, the present invention provides an improved method, apparatus, and computer instructions for allowing users of an email list to schedule temporary breaks or suspension of a subscription to the email list. The mechanism of the present invention allows a user to set a period of time during which email is not sent to the user from the email listserver. The mechanism is implemented as a graphical user interface, which may be presented, for example, through a Web page or through a Web service in which the user may schedule suspension of a subscription using an extensible markup language markup based input or request. In this manner, users may easily request suspensions to an email list without having to request cancellation of the subscription on the date the user desires to stop receiving email from the email list and having to request a subscription to the email list when the user desires again to receive email from the email list. Further, this mechanism also avoids a moderator having to review emails for users requesting a suspension period and then the moderator having to remove the user from the list and then place the user back on the list as is currently required. The mechanism provides a way for a user to easily set a suspension period for the email listserver to handle.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for scheduling suspension of email delivery to users on an email list, the method comprising:
sending a graphical user interface to a client, wherein the graphical user interface is used to facilitate user input setting a period of time during which a user is suspended from the email list;
receiving the user input setting the period of time; and
suspending email sent to subscribers of the email list to the user during the period of time, wherein emails sent to the subscribers of the email list during the period of time remain unsent to the user after the period of time ends.

2. The method of claim 1, wherein the graphical user interface is a hypertext markup language page.

3. The method of claim 1, wherein the graphical user interface is an XML based Web service.

4. The method of claim 1, wherein the graphical user interface is provided through an applet sent to the client.

5. The method of claim 1, wherein the graphical user interface presents a pull-down menu with dates for receiving user input to set a beginning of the period of time and an ending of the period of time.

6. The method of claim 1 further comprising:
terminating the suspending step during the period of time in response to receiving a user input from the user, wherein the user input requests canceling suspension of emails from the user.

7. The method of claim 1 further comprising:
sending email from the email list to the user after the period of time has passed, wherein emails sent to subscribers of the email list during the period of time are not sent to the user.

8. The method of claim 1, wherein the sending step, the receiving step, and the suspending step are executed by an email listserv application.

9. A method in a data processing system for scheduling email for an email list, the method comprising:
presenting a graphical user interface to a user, wherein the graphical user interface is designed to receive user input designating a period of time for suspension of a subscription to the email list; and
sending the schedule to a server for the email list, wherein the subscription to the email list is suspended during the period of time and emails sent to other users are never sent to the user.

10. The method of claim 9, wherein the presenting step comprises:
displaying a hypertext markup language page to the user, wherein the hypertext markup language page contains the graphical user interface.

11. A data processing system for scheduling suspension of email delivery to users on an email list, the data processing system comprising:
a bus system;
a communications unit connected to the bus system;
a memory connected to the bus system, wherein the memory includes a set of instructions; and
a processing unit connected to the bus system, wherein the processing unit executes the set of instructions to send a graphical user interface to a client, wherein the graphical user interface is used to facilitate user input setting a period of time during which a user is suspended from the email list; receive the user input setting the period of time; and suspend email sent to subscribers of the email list to the user during the period of time in which emails sent to the subscribers of the email list during the period of time remain unsent to the user after the period of time ends.

12. A data processing system for scheduling email for an email list, the data processing system comprising:
a bus system;
a communications unit connected to the bus system;
a memory connected to the bus system, wherein the memory includes a set of instructions; and
a processing unit connected to the bus system, wherein the processing unit executes the set of instructions to present a graphical user interface to a user in which the graphical user interface is designed to receive user input designating a period of time for suspension of a subscription to the email list; and send the schedule to a server for the email list in which the subscription to the email list is suspended during the period of time and emails sent to other users are never sent to the user.

13. A data processing system for scheduling suspension of email delivery to users on an email list, the data processing system comprising:
sending means for sending a graphical user interface to a client, wherein the graphical user interface is used to facilitate user input setting a period of time during which a user is suspended from the email list;
receiving means for receiving the user input setting the period of time; and
suspending means for suspending email sent to subscribers of the email list to the user during the period of time, wherein emails sent to the subscribers of the email list during the period of time remain unsent to the user after the period of time ends.

14. The data processing system of claim 13, wherein the graphical user interface is a hypertext markup language page.

15. The data processing system of claim 13, wherein the graphical user interface is an XML based Web service.

16. The data processing system of claim 13, wherein the graphical user interface is provided through an applet sent to the client.

17. The data processing system of claim 13, wherein the graphical user interface presents a pull-down menu with dates for receiving user input to set a beginning of the period of time and an ending of the period of time.

18. The data processing system of claim 13 further comprising:
terminating means for terminating the suspending step during the period of time in response to receiving a user input from the user, wherein the user input requests canceling suspension of emails from the user.

19. The data processing system of claim 13, wherein the sending means is a first sending means and further comprising:
second sending means for sending email from the email list to the user after the period of time has passed, wherein emails sent to subscribers of the email list during the period of time are not sent to the user.

20. The data processing system of claim 13, wherein the sending means, the receiving means, and the suspending means are performed by an email listserv application.

21. A data processing system for scheduling email for an email list, the data processing system comprising:
presenting means for presenting a graphical user interface to a user, wherein the graphical user interface is designed to receive user input designating a period of time for suspension of a subscription to the email list; and
sending means for sending the schedule to a server for the email list, wherein the subscription to the email list is suspended during the period of time and emails sent to other users are never sent to the user.

22. The data processing system of claim 21, wherein the presenting step comprises:
displaying means for displaying a hypertext markup language page to the user, wherein the hypertext markup language page contains the graphical user interface.

23. A computer program product in a computer readable medium for scheduling suspension of email delivery to users on an email list, the computer program product comprising:
first instructions for sending a graphical user interface to a client, wherein the graphical user interface is used to facilitate user input setting a period of time during which a user is suspended from the email list;
second instructions for receiving the user input setting the period of time; and
third instructions for suspending email sent to subscribers of the email list to the user during the period of time, wherein emails sent to the subscribers of the email list during the period of time remain unsent to the user after the period of time ends.

24. A computer program product in a computer readable medium for scheduling email for an email list, the computer program product comprising:
first instructions for presenting a graphical user interface to a user, wherein the graphical user interface is designed to receive user input designating a period of time for suspension of a subscription to the email list; and
second instructions for sending the schedule to a server for the email list, wherein the subscription to the email list is suspended during the period of time and emails sent to other users are never sent to the user.
